(19) United States
(12) Patent Application Publication
(10) Pub. No.: US 2026/0339696 A1
(43) Pub. Date: Oct. 29, 2026

(54) CONTROL METHOD, DEVICE, AND RECORDING MEDIUM

(71) Applicant: Panasonic Intellectual Property Management Co., Ltd., Osaka (JP)

(72) Inventors: Ayaka NAKASAKA, Osaka (JP); Takeru KOIE, Saitama (JP); Kakuya YAMAMOTO, Hyogo (JP); Junji MICHIYAMA, Fukuoka (JP)

(21) Appl. No.: 19/711,198

(22) Filed: Jun. 17, 2026

Related U.S. Application Data
(63) Continuation of application No. PCT/JP2024/043635, filed on Dec. 10, 2024.
(60) Provisional application No. 63/615,349, filed on Dec. 28, 2023.

(51) Int. Cl. G06F 9/48

(52) U.S. Cl. CPC G06F 9/4806

(57) ABSTRACT

A control method according to the present disclosure is executed b a device and includes: obtaining action information related to an action performed by a user on an article to improve the state of the article; calculating, based on the action information, an improvement level indicating a degree of improvement to the state of the article; and determining, based on the improvement level, an amount of tokens to be granted to the user.

### CROSS REFERENCE TO RELATED APPLICATIONS

This is a continuation application of PCT International Application No. PCT/JP2024/043635 filed on Dec. 10, 2024, designating the United States of America, which is based on and claims priority of U.S. Provisional Patent Application No. 63/615349 filed on Dec. 28, 2023. The entire disclosures of the above-identified applications, including the specifications, drawings and claims are incorporated herein by reference in their entirety.

### FIELD

The present disclosure relates to control methods, devices, and recording media.

### BACKGROUND

Patent Literature (PTL) 1 discloses a residual value calculation device capable of easily and accurately calculating the residual value of an electrical device in order to recycle the electrical device.

### CITATION LIST

### Patent Literature

PTL 1: Japanese Unexamined Patent Application Publication No. 2001-195448

### SUMMARY

### Technical Problem

However, the technique disclosed in PTL 1 is silent about a system that can prompt a user associated with an article, such as an electrical device, to perform an action to improve the state of the article.

The present disclosure provides a control method and the like for prompting a user associated with an article to perform an action to improve the state of the article.

### Solution to Problem

A control method according to an aspect of the present disclosure executed by a device and includes: obtaining action information related to an action performed by a user on an article to improve a state of the article; calculating, based on the action information, an improvement level indicating a degree of improvement to the state of the article; and determining, based on the improvement level, an amount of tokens to be granted to the user.

Note that these general and specific aspects may be implemented using a system, a device, an integrated circuit, a computer program, or a computer-readable recording medium such as compact disc read-only memory (CD-ROM), or any combination of methods, systems, devices, integrated circuits, computer programs, and recording media.

### Advantageous Effects

The control method and the like according to the present disclosure make it possible to prompt a user associated with an article to perform an action to improve the state of the article.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of the configuration of a system according to an embodiment.

FIG. 2 is a diagram illustrating an example of the configuration of a terminal according to an embodiment.

FIG. 3 is a diagram illustrating an example of the configuration of a node according to an embodiment.

FIG. 4 is a diagram illustrating an example of the configuration of a management server according to an embodiment.

FIG. 5 is a diagram illustrating an example of the configuration of an electrical device according to an embodiment.

FIG. 6 is a diagram illustrating an example of the configuration of a log according to an embodiment.

FIG. 7 is a diagram illustrating an example of error information.

FIG. 8 is a diagram illustrating an example of request information.

FIG. 9 is a diagram illustrating an example of request acceptance information.

FIG. 10 is a sequence chart illustrating an example of the operation of a system according to an embodiment.

FIG. 11 is a sequence chart illustrating an example of the operation of a system according to Variation 1

FIG. 12 is an explanatory diagram illustrating the data structure of a blockchain.

FIG. 13 is an explanatory diagram illustrating the data structure of transaction data.

FIG. 14 is an explanatory diagram illustrating transaction data related to execution of a smart contract.

FIG. 15 is an explanatory diagram illustrating processing related to execution of a smart contract.

### DESCRIPTION OF EMBODIMENT

A control method according to the first aspect of the present disclosure is executed by a device and includes: obtaining action information related to an action performed by a user on an article to improve a state of the article; calculating, based on the action information, an improvement level indicating a degree of improvement to the state of the article; and determining, based on the improvement level, an amount of tokens to be granted to the user.

With this, the amount of tokens to be granted to a user who has performed an action on an article to improve the state of the article can be determined based on the improvement level indicating the degree of improvement to the state of the article. Thus, it is possible to prompt a user to perform an action to improve the state of the article, thereby enabling the value of the article to be enhanced or preserved so as not to be degraded.

A control method according to the second aspect of the present disclosure is the control method according to the first aspect in which the action includes at least one of: performing a task on the article; requesting a specialized service provider for the task to perform the task; properly using the article; or designing a structure for enabling value measurement of the article.

A control method according to the third aspect of the present disclosure is the control method according to the second aspect that further includes obtaining error information indicating an error that has occurred in an electrical device that is the article. The action is performing, by the specialized service provider, a task to correct the error in the electrical device, as the task performed on the electrical device.

With this, the amount of tokens to be granted to a specialized service provider who has performed a task to correct an error in the article, i.e., an electrical device, can be determined. Thus, it is possible to prompt a specialized service provider to perform an action to improve the state of the electrical device, thereby enabling the value of the electrical device to be enhanced or preserved so as not to be degraded.

A control method according to the fourth aspect of the present disclosure is the control method according to the third aspect in which the improvement level is calculated based on a period from when the error occurs to when the task to correct the error is performed.

With this, the action performed by a user can be properly assessed.

A control method according to the fifth aspect of the present disclosure is the control method according to the fourth aspect in which when the period is greater than or equal to a predetermined period, the determining is skipped.

With this, when said period does not satisfy the condition, the process of determining the amount of tokens can be skipped. Thus, the processing load can be reduced.

A control method according to the sixth aspect of the present disclosure is the control method according to the fourth or fifth aspect that further includes obtaining, from a first terminal of the specialized service provider, request acceptance information indicating that a job request from an owner of the electrical device to perform the task to correct the error has been accepted. The period is a period from a point in time at which the error occurs to a point in time at which the request acceptance information is obtained.

A control method according to the seventh aspect of the present disclosure is the control method according to the sixth aspect in which the action includes: performing, by the specialized service provider for the task, the task to correct the error in the electrical device, as the task performed on the electrical device; and requesting, by the owner, the specialized service provider for the task to perform the task, and in the determining, a first amount of tokens to be granted to the specialized service provider and a second amount of tokens to be granted to the owner are determined as the amount of tokens.

With this, tokens can be granted to both an owner who has requested the task and a service provider who has performed the task. Thus, it is possible to prompt both an owner and a service provider to perform an action to improve the state of the electrical device, thereby enabling the value of the electrical device to be enhanced or preserved so as not to be degraded.

A control method according to the eighth aspect of the present disclosure is the control method according to the fourth or fifth aspect that further includes obtaining, from a first terminal of the specialized service provider, completion information indicating that the specialized service provider has completed the task to correct the error. The period is a period from a point in time at which the error occurs to a point in time at which the completion information is obtained.

A control method according to the ninth aspect of the present disclosure is the control method according to the eighth aspect in which the action includes performing, by the specialized service provider, the task to correct the error in the electrical device, as the task performed on the electrical device, and in the determining, a first amount of tokens to be granted to the specialized service provider is determined as the amount of tokens.

With this, the amount of tokens to be granted to a specialized service provider who has performed a task to correct an error in the electrical device can be determined. Thus, it is possible to prompt a specialized service provider to perform an action to improve the state of the electrical device, thereby enabling the value of the electrical device to be enhanced or preserved so as not to be degraded.

A control method according to the tenth aspect of the present disclosure is the control method according to the fourth or fifth aspect that further includes obtaining a log indicating that the error in the electrical device has been corrected. The period is a period from a point in time at which the error occurs to a point in time at which the error is corrected.

A control method according to the eleventh aspect of the present disclosure is the control method according to the third aspect in which the electrical device is capable of communication via a network, the action information is a log generated by the electrical device, and is obtained from the electrical device via the network, and in the calculating, whether the user has properly used the electrical device is judged based on the log that is the action information, and the improvement level is calculated based on a result of the judging.

A control method according to the twelfth aspect of the present disclosure is the control method according to the third aspect in which the device includes a distributed ledger in which a smart contract used in the calculating and the determining is stored, in the obtaining, transaction data including the action information is obtained, and in the calculating and the determining, the smart contract is executed based on the action information included in the transaction data.

A device according to the thirteenth aspect of the present disclosure includes: a processor; and memory. Using the memory, the processor: obtains action information related to an action performed by a user on an article to improve a state of the article; calculates, based on the action information, an improvement level indicating a degree of improvement to the state of the article; and determines, based on the improvement level, an amount of tokens to be granted to the user.

With this, the amount of tokens to be granted to a user who has performed the action on the article to improve the state of the article can be determined based on the improvement level indicating the degree of improvement to the state of the article. Thus, it is possible to prompt a user to perform an action to improve the state of the article, thereby enabling the value of the article to be enhanced or preserved so as not to be degraded.

A recording medium according to the fourteenth aspect of the present disclosure is a non-transitory computer-readable recording medium having stored therein a program for causing a computer to execute a control method including: obtaining action information related to an action performed by a user on an article to improve a state of the article; calculating, based on the action information, an improvement level indicating a degree of improvement to the state of the article; and determining, based on the improvement level, an amount of tokens to be granted to the user.

Note that these general and specific aspects may be implemented using a system, a device, an integrated circuit, a computer program, or a computer-readable recording medium such as CD-ROM, or any combination of methods, systems, devices, integrated circuits, computer programs, or recording media.

Hereinafter, an embodiment will be described with reference to the drawings. Note that each embodiment described below shows one specific example of the present disclosure. The numerical values, shapes, materials, structural elements, the arrangement and connection of the structural elements, steps, the processing order of the steps, etc., shown in the following embodiment are mere examples, and are not intended to limit the present disclosure. Among the structural elements in the following embodiment, structural elements not recited in any one of the independent claims which indicate the broadest concepts are not necessarily required to achieve the object of the present disclosure, but are described as structural elements included in a more preferred embodiment.

### Embodiment

The present embodiment describes a control method for prompting a user associated with an electrical device to perform an action to improve or preserve the value of the electrical device.

Said action is performed by a user on an electrical device. The action for improving or preserving the value of the electrical device (hereinafter, the action for the value of the electrical device) includes at least one of: performing a task on the electrical device; requesting a service provider specialized in said task to perform the task; properly using said electrical device; and designing a structure for enabling value measurement of said electrical device.

Examples of the task performed on the electrical device include repairing, restoring, cleaning, and replacing a component of the electrical device. Examples of the action of properly using the electrical device include: configuring the settings of the electrical device in accordance with a predetermined usage standard; maintaining appropriate usage environment (e.g., temperature or humidity); complying with a limit related to of usage duration or usage frequency; and performing periodic maintenance or cleaning. Examples of designing a structure for enabling value measurement of the electrical device include: designing a readily disassemblable structure; designing a module; selecting a highly recyclable material; designing a high-durability structure that aims to extend the product life; creating a design for reuse or upcycling; creating a compact design for improved storage; creating a sorting-facilitated design; creating an integrally molded design for waste reduction; and creating a design for improved traceability.

Note that examples of the user include a user who performs these actions. Specifically, examples of the user include: a user who performs a task; a user who issues a job request; a user who properly uses the electrical device; and a user who designs a structure for the electrical device.

### System Configuration

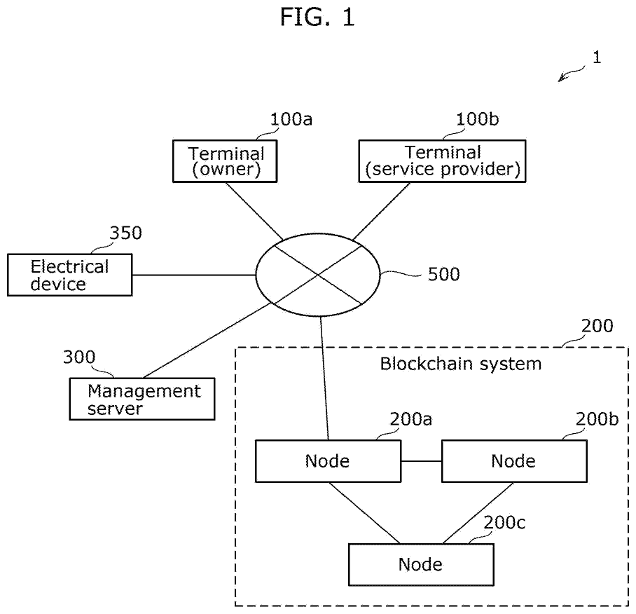

FIG. 1 is a diagram illustrating an example of the configuration of a system according to an embodiment.

As illustrated in FIG. 1, system 1 includes terminals 100a, 100b, blockchain system 200, management server 300, and electrical device 350. Blockchain system 200 includes nodes 200a to 200c.

Terminals 100a, 100b, blockchain system 200, management server 300, and electrical device 350 may all be connected to each other by network 500, may all be directly connected to allow communication therebetween, or some of these elements may be connected by network 500 while some other elements are directly connected to allow communication therebetween. Network 500, which is the Internet or a cell-phone carrier network, for example, may include any communication line or network.

Terminal 100a is operated by the owner of electrical device 350. Terminal 100a may present the processing result to the owner.

Terminal 100b is operated by a service provider. Terminal 100b may present the processing result to the service provider. The service provider is the specialized service provider mentioned above.

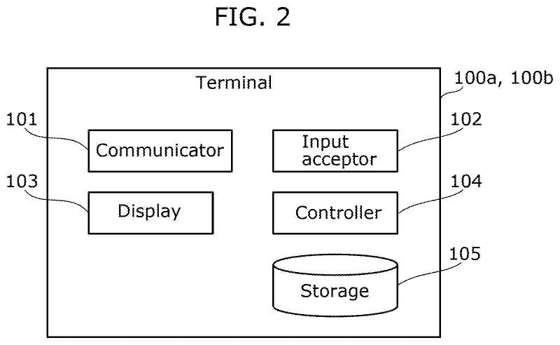

FIG. 2 is a diagram illustrating an example of the configuration of the terminal according to the embodiment.

Each of terminals 100a, 100b includes communicator 101, input acceptor 102, display 103, controller 104, and storage 105.

Communicator 101 may transmit information to the other of terminals 100a, 100b or nodes 200a to 200c via network 500 and may receive information from other terminal or nodes 200a to 200c via network 500. The other terminal refers to one of terminals 100a, 100b that is different from the terminal including said communicator 101. Communicator 101 of terminal 100a may transmit request information to terminal 100b. Communicator 101 of terminal 100b may transmit request acceptance information to blockchain system 200. Note that the request information and the request acceptance information will be described in detail later.

In this manner, communicator 101 performs communication with the other terminals or nodes 200a to 200c via network 500. Note that this communication may be performed using transport layer security (TLS) and a cryptographic key for TLS communication may be held in communicator 101. Communicator 101 is embodied using an input interface (IF).

Input acceptor 102 accepts input from a user. Input acceptor 102 displays the accepted input on display 103, transmits the accepted input to controller 104, and transmits the accepted input to communicator 101, for example. Input acceptor 102 is embodied using an input interface (IF).

Display 103 displays a user interface (UI) that allows input acceptor 102 to accept input. Furthermore, display 103 displays, on the UI, the input accepted by input acceptor 102. Display 103 may display the information reported from nodes 200a to 200c. Display 103 is embodied using a display device.

Controller 104 generates transaction data on the basis of the information input accepted by input acceptor 102, and transmits the generated transaction data to nodes 200a to 200c via communicator 101. Controller 104 is embodied using a processor.

Storage 105 stores the information received by communicator 101, the input accepted by input acceptor 102, and the transaction data generated by controller 104, for example. Storage 105 may store data other than said information. Storage 105 is embodied using a storage device.

Each of terminals 100a, 100b is embodied using a processor executing a predetermined program using memory.

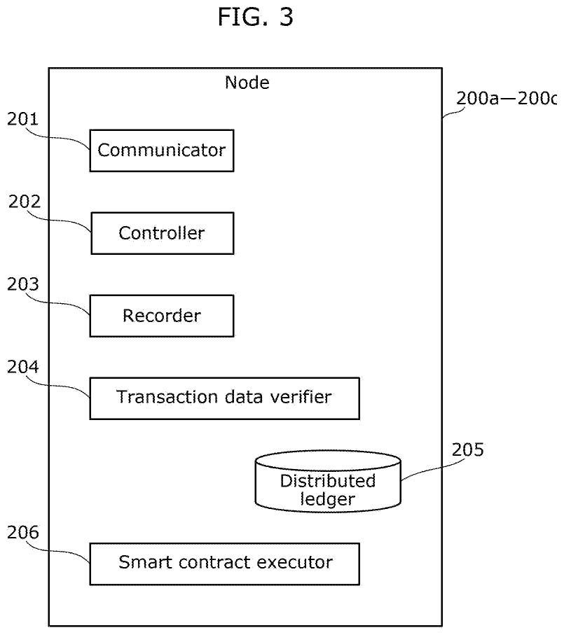

FIG. 3 is a diagram illustrating an example of the configuration of the node according to the embodiment.

Each of nodes 200a to 200c includes communicator 201, controller 202, recorder 203, transaction data verifier 204, distributed ledger 205, and smart contract executor 206, as illustrated in FIG. 3. Each of nodes 200a to 200c is an example of a device (control device) that manages one or more blockchains.

Communicator 201 transmits information to at least one of terminals 100a, 100b, other nodes among nodes 200a to 200c, and management server 300 via network 500 or receives information from at least one of terminals 100a, 100b, other nodes among nodes 200a to 200c, and management server 300 via network 500, for example. The other nodes refer to at least one of nodes 200a to 200c that is different from the node including said communicator 201. Furthermore, communicator 201 transmits and receives the transaction data to and from other nodes 200a to 200c.

In this manner, communicator 201 communicates with at least one of terminals 100a, 100b, other nodes among nodes 200a to 200c, and management server 300 via network 500. Note that this communication may be performed using transport layer security (TLS) and a cryptographic key for TLS communication may be held in communicator 201.

Controller 202 executes a consensus algorithm on the transaction data received by communicator 201. Thus, controller 202 stores said transaction data in distributed ledger 205. For example, controller 202 connects a block including the transaction data to the blockchain of distributed ledger 205 and thus stores, in the blockchain, the information included in said transaction data.

When communicator 201 receives transaction data, transaction data verifier 204 verifies the authenticity of said transaction data. For example, transaction data verifier 204 verifies whether an electronic signature generated in a proper method has been provided to the transaction data received by communicator 201. When the authenticity is verified, communicator 201 transmits a copy of the transaction data to a plurality of other nodes 200a to 200c, and thus the verified authentication transaction data is recorded in recorder 203 of each of other nodes 200a to 200c. Thus, only the transaction data whose authenticity has been verified is transmitted to other servers, which reduces the increase in power consumption of the computer. Note that this verification may be skipped.

Furthermore, together with the plurality of other nodes 200a to 200c, transaction data verifier 204 executes a consensus algorithm to agree on the authenticity of the transaction data.

As the consensus algorithm, practical byzantine fault tolerance (PBFT) may be used, or other known consensus algorithms may be used. Examples of the known consensus algorithms include proof of work (PoW) and proof of stake (PoS). When the PBFT is used as the consensus algorithm, transaction data verifier 204 receives, from each of the plurality of nodes 200a to 200c, a report indicating whether the verification of the transaction data has been successful, and judges whether the number of said reports exceeds a predetermined number. It is sufficient that when the number of said reports exceeds the predetermined number, transaction data verifier 204 judge that the authenticity of the transaction data has been verified using the consensus algorithm.

When transaction data verifier 204 confirms the authenticity of the transaction data, transaction data verifier 204 causes recorder 203 to record said transaction data. When the authenticity of the transaction data is not verified, transaction data verifier 204 discards the transaction data. As a result, the transaction data that fails authenticity verification is not recorded into recorder 203; therefore, the required amount of computer resources can be reduced. Transaction data verifier 204 may generate a block including the transaction data with confirmed authenticity and store the generated block in distributed ledger 205.

In the present embodiment, transaction data verifier 204 verifies the authenticity of the transaction data received by communicator 201.

Note that recorder 203 stores, in distributed ledger 205, the transaction data with authenticity verified by transaction data verifier 204, thereby recording the transaction data. Thus, the transaction data can be protected from tampering.

Note that recorder 203 may be formed inside distributed ledger 205.

In distributed ledger 205, transaction data is stored. Since distributed ledger 205 sequentially obtains and stores transaction data, transaction data for one or more transactions is stored in distributed ledger 205. Distributed ledger 250 is embodied using storage. Smart contract executor 206 operates the smart contract by executing a contract code, etc., included in the transaction data stored in the blockchain of distributed ledger 205.

In this manner, by operating smart contracts, smart contract executor 206 can manage various processes using distributed ledger 205. Note that the smart contracts are generated using applications on nodes 200a to 200c or terminals 100a, 100b on the basis of operations performed by users, for example, and blocks including the smart contracts have been stored in blockchains in advance. This means that the contract codes of the smart contracts are stored in blockchains.

Note that the contract codes of the smart contracts may be separately stored in the blockchains or may be stored in the blockchains as one integrated contract code.

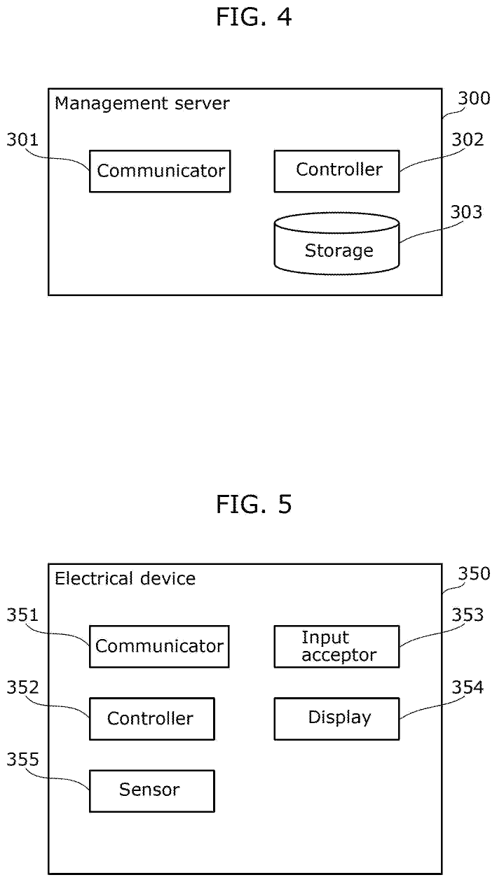

FIG. 4 is a diagram illustrating an example of the configuration of the management server according to the embodiment.

Management server 300 includes communicator 301, controller 302, and storage 303.

Communicator 301 transmits information to at least one of terminals 100a, 100b, blockchain system 200, and electrical device 350 via network 500 or receives information from at least one of terminals 100a, 100, blockchain system 200, and electrical device 350 via network 500, for example.

The information transmitted to blockchain system 200 is, for example, transaction data generated by management server 300. The information received from blockchain system 200 is, for example, a notification regarding the amount of tokens calculated by blockchain system 200. Each time transaction data is generated, communicator 301 transmits the generated transaction data to blockchain system 200.

The information received from terminal 100a is, for example, owner information including an owner ID for identifying the owner of electrical device 350 and device information including a device ID for identifying electrical device 350. The information received from electrical device 350 is, for example, a log generated in electrical device 350 or error information indicating an error that has occurred in electrical device 350.

In this manner, communicator 301 communicates with at least one of terminals 100a, 100b, blockchain system 200, and electrical device 350 via network 500. Note that this communication may be performed using transport layer security (TLS) and a cryptographic key for TLS communication may be held in communicator 301.

Controller 302 generates a smart contract defining a rule for calculating tokens to be granted to a user who has performed the action for the value of the electrical device. The smart contract includes, for example, a contract code for calculating, based on transaction data including information indicating that a task to correct an error has been performed, the amount of tokens to be granted to a user who has performed the action regarding said task. In the smart contract, data stored in distributed ledger 205 is referred to, and the period from when an error occurs in electrical device 350 to when the task to correct said error is performed is specified based on the transaction data including the information indicating that the task to correct the error has been performed. Subsequently, the amount of tokens is calculated based on the specified period. Note that the tokens may possess monetary value usable in sales transactions, or may serve as indicators that can be exchanged for monetary value. The indicators that can be exchanged include a warranty period for electrical device 350 or may be the value of electrical device 350 itself.

Controller 302 generates error transaction data including the error information received from electrical device 350, and causes communicator 301 to transmit the generated error transaction data to blockchain system 200. Controller 302 generates log transaction data including the log received from electrical device 350, and causes communicator 301 to transmit the generated log transaction data to blockchain system 200.

Storage 303 stores, for example, the information received by communicator 301 and the transaction data generated by controller 302. Storage 303 may store data other than said information. Storage 303 is embodied using a storage device.

FIG. 5 is a diagram illustrating an example of the configuration of the electrical device according to the embodiment.

Electrical device 350 includes communicator 351, controller 352, input acceptor 353, display 354, and sensor 355.

Communicator 351 transmits information to terminal 100a or management server 300 via network 500 or receives information from terminal 100a or management server 300 via network 500, for example.

Specifically, communicator 351 may transmit, to terminal 100a, the device information including the device ID for identifying electrical device 350. Furthermore, communicator 351 may transmit, to management server 300, the log recorded by electrical device 350. Communicator 351 is embodied, for example, using a communication IF included in electrical device 350.

Controller 352 performs an operation indicated in a control instruction received by communicator 351 or a control instruction accepted by input acceptor 353. When a point in time at which the operation is to be performed is designated in the control instruction, controller 352 performs said operation at the designated point in time. Controller 352 is embodied, for example, using a processor.

Input acceptor 353 accepts input from a user. Specifically, input acceptor 353 accepts input to the UI displayed on display 354. Input acceptor 353 is embodied, for example, using an input IF such as a touch panel. Note that input acceptor 353 is not limited to a touch panel, and may be another input IF such as a physical button or a voice input device.

Display 354 displays an UI or an image generated by electrical device 350 or management server 300. Display 354 is embodied, for example, using a display device.

Sensor 355 is configured to detect a state of electrical device 350. Note that electrical device 350 is not limited to including single sensor 355, and may include a plurality of sensors 355. The plurality of sensors 355 may be of the same type or of different types.

When electrical device 350 is a washing machine, sensor 355 may be, for example, a sensor that measures a water level, a sensor that measures a temperature, or a sensor that measures the value of an electric current for operating an actuator (for example, a motor that rotates a washing tub) of the washing machine.

When electrical device 350 is a refrigerator, the sensor may be, for example, a sensor that measures an internal temperature of a refrigerator or a sensor that measures the value of an electric current for operating an actuator (for example, a motor that drives a compressor) of the refrigerator.

When electrical device 350 is a rice cooker, the sensor may be, for example, a sensor that measures the temperature of the bottom of the inner pot of the rice cooker.

Note that electrical device 350 may omit at least one of input acceptor 353 and display 354. In this case, electrical device 350 may communicate with terminal 100a, for example, to implement the functions of input acceptor 353 by receiving information accepted on terminal 100a, and implement the functions of display 354 by transmitting display information to terminal 100a and causing terminal 100a to display the display information.

Note that the log of electrical device 350 indicates the operational history of electrical device 350. The operational history includes the operation performed by electrical device 350 and the date and time at which the operation has been performed. The operational history may further include a duration of the operation. Examples of the operation indicated in the operational history may include the driving of the actuators included in electrical device 350, the detection results of the sensors included in electrical device 350, the processing details of the central processing unit (CPU) included in electrical device 350, and the computational outcomes of the CPU included in electrical device 350.

Next, information exchanged in system 1 will be described.

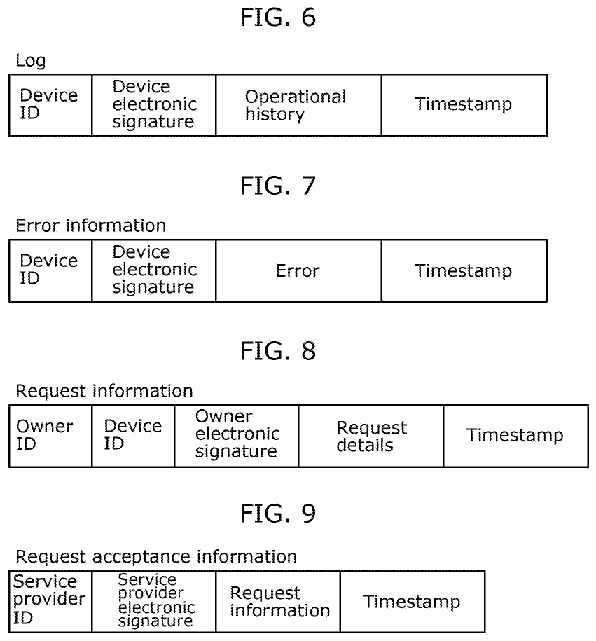

FIG. 6 is a diagram illustrating an example of the configuration of the log.

The log is generated by electrical device 350. The log includes: the device ID of electrical device 350 in which said log has been generated; the device electronic signature of said electrical device 350; the operational history of electrical device 350; and a timestamp indicating the point in time at which said operational history has been generated.

FIG. 7 is a diagram illustrating an example of the error information.

The error information is generated by electrical device 350. The error information includes: the device ID of electrical device 350 in which an error has occurred; the device electronic signature of said electrical device 350; an error code (malfunction code) indicating the error that has occurred; and a timestamp indicating the point in time at which said error has occurred. Note that the error information may be one type of the log. In other words, the operational history in the log may include an error code generated in electrical device 350.

FIG. 8 is a diagram illustrating an example of the request information.

The request information is generated by terminal 100a. The request information is generated based on owner input to terminal 100a. The request information is information transmitted to terminal 100b of a service provider upon the occurrence of an error in electrical device 350, thereby requesting the service provider to perform a task to correct the error. The request information includes: an owner ID for identifying the owner; a device ID for identifying electrical device 350 in which the error has occurred; an owner electronic signature which is the electronic signature of the owner; request details indicating the task to correct the error; and a timestamp indicating the point in time at which the request information has been generated. The request details may include error information indicating the target error to be corrected by the task.

FIG. 9 is a diagram illustrating an example of the request acceptance information.

The request acceptance information is generated by terminal 100b. The request acceptance information is generated based on service provider input to terminal 100b. When the service provider accepts the job request to correct the error, the request acceptance information is generated and is transmitted to blockchain system 200. The request acceptance information includes: a service provider ID for identifying the service provider; a service provider electronic signature which is the electronic signature of the service provider; request information indicating the accepted request; and a timestamp indicating the point in time at which the request information has been accepted.

### Operation

Next, the operation of system 1 configured as described above will be described.

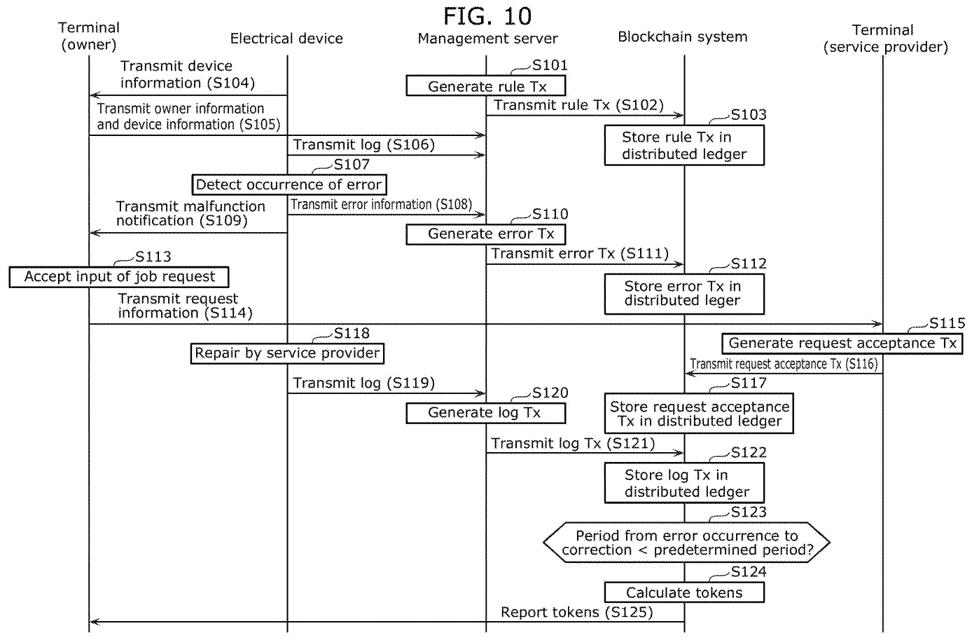

FIG. 10 is a sequence chart illustrating an example of the operation of the system according to the embodiment.

Management server 300 generates rule transaction data (rule Tx) (S101).

Management server 300 transmits the rule transaction data to blockchain system 200 (S102). Accordingly, blockchain system 200 receives the rule transaction data from management server 300.

Blockchain system 200 executes a consensus algorithm to store the received rule transaction data in distributed ledger 205 (S103). Accordingly, the smart contract included in the rule transaction data is deployed.

Electrical device 350 transmits the device information including the device ID of said electrical device 350 to terminal 100a (S104). For example, Step S104 may be performed in response to owner input to electrical device 350. Furthermore, Step S104 may be performed in response to a device information transmission request from terminal 100a. The transmission request may be transmitted from terminal 100a to electrical device 350 in response to owner input to terminal 100a. Thus, terminal 100a receives the device information from electrical device 350.

Terminal 100a transmits the owner information including the owner ID and the received device information to management server 300 (S105). Accordingly, management server 300 receives the owner information and the device information from terminal 100a. Management server 300 stores, in association with each other, the owner ID included in the received owner information and the device ID included in the device information.

Electrical device 350 transmits the log to management server 300 (S106). Accordingly, management server 300 receives the log from electrical device 350.

Electrical device 350 detects the occurrence of an error (S107). For example, electrical device 350 may detect the occurrence of an error when the detection result of sensor 355 deviates from a predetermined range, or may detect the occurrence of an error when an operation that follows an operation instruction is not performed despite issuance of the operation instruction to an actuator.

Electrical device 350 generates the error information indicating the detected error, and transmits the error information to management server 300 (S108). Accordingly, management server 300 receives the error information from electrical device 350.

Furthermore, electrical device 350 transmits a malfunction notification for notifying the owner of the error information to terminal 100a (S109). The malfunction notification may include, for example, the error information and a UI for reporting the error information to terminal 100a. Accordingly, terminal 100a receives the malfunction notification from electrical device 350. Terminal 100a may display the received malfunction notification.

Management server 300 generates error transaction data (error Tx) including the received error information (S110).

Management server 300 transmits the error transaction data to blockchain system 200 (S111). Accordingly, blockchain system 200 receives the error transaction data from management server 300.

Blockchain system 200 executes a consensus algorithm to store the received error transaction data in distributed ledger 205 (S112).

Terminal 100a accepts, from the owner, input indicating a request perform a task to correct the error (a job request) (S113). Terminal 100a generates the request information on the basis of the input.

Terminal 100a transmits the generated request information to terminal 100b of the service provider (S114). The service provider may be designated on terminal 100a on the basis of owner input thereto, and the request information is transmitted to terminal 100b of the designated service provider. Accordingly, terminal 100b receives the request information from terminal 100a.

On the basis of the received request information and the input from the service provider, terminal 100b generates the request acceptance information, and generates request acceptance transaction data (request acceptance Tx) including the request acceptance information (S115).

Terminal 100b transmits the generated request acceptance transaction data to blockchain system 200 (S116). Accordingly, blockchain system 200 receives the request acceptance transaction data from terminal 100b.

Blockchain system 200 executes a consensus algorithm to store the received request acceptance transaction data in distributed ledger 205 (S117).

Electrical device 350 undergoes repair work by the service provider as the task to correct to the error (S118). Thus, the error is corrected.

Electrical device 350 generates a log indicating that the error has been corrected, and transmits said log to management server 300 (S119). Accordingly, management server 300 receives, from electrical device 350, the log indicating that the error has been corrected. Note that the correction of the error may be indicated not only by transmitting the log showing that the error has been corrected, but also implicitly by transmitting a log that contains no error. Note that electrical device 350 may issue an operation instruction to an actuator and when an operation that follows the operation instruction is successfully performed, generate the log.

Management server 300 generates log transaction data (log Tx) including the received log (S120).

Management server 300 transmits the log transaction data to blockchain system 200 (S121). Accordingly, blockchain system 200 receives the log transaction data from management server 300.

Blockchain system 200 executes a consensus algorithm to store the received log transaction data in distributed ledger 205 (S122).

Blockchain system 200 executes the smart contract on the basis of the log transaction data, thereby judging whether the period from when the error occurs to when the task to correct the error is performed is less than a predetermined period (S123).

When the period from when the error occurs to when the task to correct the error is performed is less than the predetermined period, blockchain system 200 calculates an amount of tokens to be granted to the owner (S124). For example, blockchain system 200 may determine, as the amount of tokens to be granted to the owner, a predetermined amount of tokens or an amount of tokens that increases as the period decreases. Note that Step S124 may also be included in the process performed by the smart contract.

Blockchain system 200 notifies terminal 100a of the owner that the calculated amount of tokens has been granted to the owner (S125).

In this manner, by receiving the request acceptance information, blockchain system 200 obtains the request information indicating the request to perform the task to correct the error, as the action performed by the user on electrical device 350 (S116). Furthermore, based on the request information, blockchain system 200 calculates the period from when the error occurs to when the task to correct the error is performed, as an improvement level indicating the degree of improvement to the state of electrical device 350 (S123). Blockchain system 200 determines, based on the period calculated as the improvement level, an amount of tokens to be granted to the owner as a user (S124).

Note that the above-described processes performed by blockchain system 200, including the process of storing the transaction data in distributed ledger 205 in cooperation with the other nodes, may be interpreted as processes performed by each of nodes 200a to 200c.

Note that in Step S124, blockchain system 200 may calculate an amount of tokens to be granted to the service provider. This is because the action for improving the state of electrical device 350 includes a task performed on electrical device 350, specifically, a task performed to correct an error in electrical device 350.

### Advantageous Effects, etc.

Blockchain system 200 according to the present embodiment executes the following control method. Blockchain system 200 obtains request information (action information) indicating an action performed by an owner (a user on electrical device 350) to request a service provider to perform a task to correct an error (an action to improve the state of electrical device 350). Blockchain system 200 calculates, based on the request information (the action information), the period from when the error occurs to when the error is corrected (an improvement level indicating a degree of improvement to the state of electrical device 350). Blockchain system 200 determines, based on the period from when the error occurs to when the error is corrected (the improvement level), an amount of tokens to be granted to the user.

As a result, the amount of tokens to be granted to a user who has performed an action on electrical device 350 to improve the state of electrical device 350 can be determined based on the improvement level indicating the degree of improvement to the state of electrical device 350. Thus, it is possible to prompt a user to perform an action to improve the state of electrical device 350, thereby enabling the value of electrical device 350 to be enhanced or preserved so as not to be degraded.

Furthermore, blockchain system 200 according to the present embodiment further obtains error transaction data including error information indicating an error that has occurred in electrical device 350. The action for improving the state of electrical device 350 is performing, by the specialized service provider, the task to correct the error in electrical device 350, as the task performed on electrical device 350.

As a result, the amount of tokens to be granted to a service provider who has performed an action to correct to the error in electrical device 350 can be determined. Thus, it is possible to prompt a service provider to perform an action to improve the state of electrical device 350, thereby enabling the value of electrical device 350 to be enhanced or preserved so as not to be degraded.

Furthermore, in blockchain system 200 according to the present embodiment, the improvement level may be calculated based on the period from when the error occurs to when the task to correct the error is performed. The improvement level may be the period itself or may be an indicator determined according to the period.

Accordingly, the action performed by the user can be properly assessed.

Furthermore, in blockchain system 200 according to the present embodiment, when the period from when the error occurs to when the task to correct the error is performed is greater than or equal to a predetermined period, the amount of tokens does not need to be determined.

Accordingly, when said period does not satisfy the condition, the process of determining the amount of tokens can be skipped. Thus, the processing load on a processor can be reduced.

Furthermore, blockchain system 200 according to the present embodiment obtains, from terminal 100b (a first terminal) of the service provider, request acceptance information indicating that a job request from the owner of electrical device 350 to perform the task to correct the error has been accepted. The period from when the error occurs to when the task to correct the error is performed is the period from the point in time at which the error occurs to the point in time at which the request acceptance information is obtained.

Furthermore, in blockchain system 200 according to the present embodiment, the action for improving the state of electrical device 350 includes: performing, by the service provider, the task to correct the error in electrical device 350, as the task performed on electrical device 350; and requesting, by the owner, the service provider (specialized in the task) to perform the task. In determining the amount of tokens, a first amount of tokens to be granted to the service provider and a second amount of tokens to be granted to the owner are determined as the amount of tokens.

Accordingly, tokens can be granted to both an owner who has requested the task and a service provider who has performed the task. Thus, it is possible to prompt both an owner and a service provider to perform an action to improve the state of electrical device 350, thereby enabling the value of electrical device 350 to be enhanced or preserved so as not to be degraded.

Furthermore, blockchain system 200 according to the present embodiment may further obtain, from terminal 100b of the service provider, completion information indicating that the service provider has completed the task to correct the error. The period from when the error occurs to when the task to correct the error is performed is the period from the point in time at which the error occurs to the point in time at which the completion information is obtained.

Furthermore, in blockchain system 200 according to the present embodiment, the action for improving the state of electrical device 350 includes performing, by the service provider, the task to correct the error in electrical device 350, as the task performed on electrical device 350. In determining the amount of tokens, a first amount of tokens to be granted to the service provider is determined as the amount of tokens.

As a result, the amount of tokens to be granted to a specialized service provider who has performed an action to correct to the error in electrical device 350 can be determined. Thus, it is possible to prompt a specialized service provider to perform an action to improve the state of electrical device 350, thereby enabling the value of electrical device 350 to be enhanced or preserved so as not to be degraded.

Furthermore, blockchain system 200 according to the present embodiment further obtains a log indicating that the error in electrical device 350 has been corrected. The period from when the error occurs to when the task to correct the error is performed is the period from the point in time at which the error occurs to the point in time indicated by a timestamp included in the log after the error has been corrected.

### Variation 1

The operation of system 1 according to Variation 1 will be described. In the above embodiment, the amount of tokens is determined based on the period from when an error occurs to when the error is corrected. Variation 1 is an example where the amount of tokens is determined based on the log received from electrical device 350.

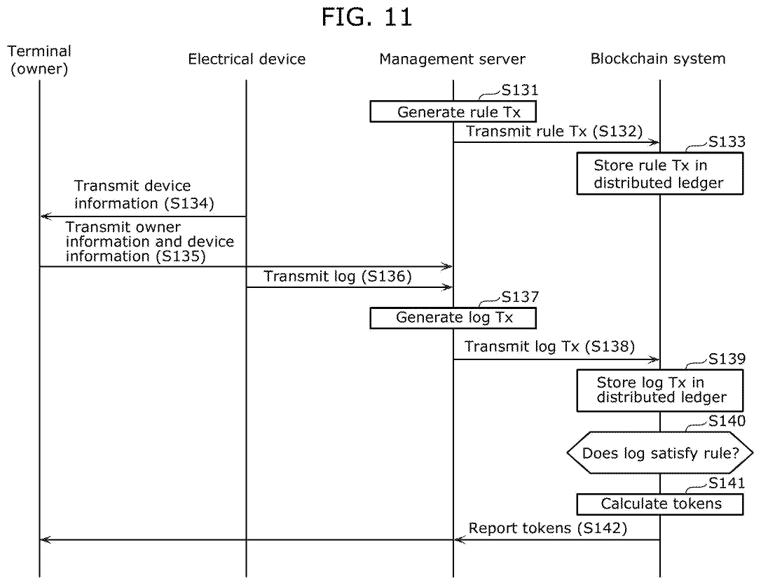

FIG. 11 is a sequence chart illustrating an example of the operation of the system according to Variation 1.

Management server 300 generates rule transaction data (rule Tx) (S131).

Management server 300 transmits the rule transaction data to blockchain system 200 (S132). Accordingly, blockchain system 200 receives the rule transaction data from management server 300.

Blockchain system 200 executes a consensus algorithm to store the received rule transaction data in distributed ledger 205 (S133). Accordingly, the smart contract included in the rule transaction data is deployed.

Electrical device 350 transmits the device information including the device ID of said electrical device 350 to terminal 100a (S134). For example, Step S134 may be performed according to owner input to electrical device 350. Furthermore, Step S134 may be performed in response to a device information transmission request from terminal 100a. The transmission request may be transmitted from terminal 100a to electrical device 350 in response to owner input to terminal 100a. Thus, terminal 100a receives the device information from electrical device 350.

Terminal 100a transmits the owner information including the owner ID and the received device information to management server 300 (S135). Accordingly, management server 300 receives the owner information and the device information from terminal 100a. Management server 300 stores, in association with each other, the owner ID included in the received owner information and the device ID included in the received device information.

Electrical device 350 transmits the log to management server 300 (S136). Accordingly, management server 300 receives the log from electrical device 350.

Management server 300 generates log transaction data (log Tx) including the received log (S137).

Management server 300 transmits the log transaction data to blockchain system 200 (S138). Accordingly, blockchain system 200 receives the log transaction data from management server 300.

Blockchain system 200 executes a consensus algorithm to store the received log transaction data in distributed ledger 205 (S139).

Blockchain system 200 executes the smart contract on the basis of the log transaction data, thereby judging whether the owner has properly used electrical device 350 (judging whether the log satisfies the rule) and calculating the improvement level on the basis of the result of the judgement (S140). Whether electrical device 350 has been properly used may be judged, for example, based on the action to configure the settings of electrical device 350 in accordance with a predetermined usage standard; the action to maintain appropriate usage environment (e.g., temperature or humidity); the action to comply with a limit related to of usage duration or usage frequency; and the action to perform periodic maintenance or cleaning. Whether electrical device 350 has been properly used may be judged based on each log, and the number of times electrical device 350 has been judged as having been properly used may be calculated as the improvement level. The improvement level may be a value calculated by subtracting the number of times electrical device 350 has been judged as not having been properly used from the number of times electrical device 350 has been judged as having been properly used.

Furthermore, the log may be weighted, and the aforementioned number of times may be converted into a value corresponding to the weight. For example, a log indicating that electrical device 350 has been used in a manner that significantly affects the product life thereof may be weighted so that the improvement level is calculated by subtracting the number of times greater than the number of times for one log. Conversely, for example, a log indicating that electrical device 350 has been used in a manner that barely affects the product life thereof may be weighted so that the improvement level is calculated by subtracting the number of times less than the number of times for one log.

Furthermore, calculating the improvement level on the basis of each log is not the only option; a plurality of logs may be used to calculate the improvement level. For example, when a plurality of logs indicate that periodic maintenance has been performed, the improvement level may be calculated to be higher. Furthermore, for example, for electrical device 350 including a battery, the improvement level may be calculated to be higher based on the logs indicating that said electrical device 350 has been periodically charged. Moreover, the improvement level may be calculated to be higher based on the logs indicating that the state of charge of electrical device 350 transitions so as to remain within a range excluding the ranges close to 0% and 100% (for example, within the ranges of 0% to 20% and 80% to 100%).

Blockchain system 200 calculates, according to the improvement level, an amount of tokens to be granted to the owner (S141). For example, blockchain system 200 may determine, as the amount of tokens to be granted to the owner, a predetermined amount of tokens or an amount of tokens that increases as the period decreases. Note that Step S141 may also be included in the process performed by the smart contract.

Blockchain system 200 notifies terminal 100a of the owner that the calculated amount of tokens has been granted to the owner (S142).

### Variation 2

In the above embodiment, management server 300 may function as one of the plurality of nodes included in blockchain system 200.

### Variation 3

The above embodiment describes a control method for prompting

user associated with an electrical device to perform an action to improve or preserve the value of the electrical device. The target of the action performed by the user is an electrical device, but may be an article. Specifically, the control method may be for prompting a user associated with an article to perform an action to improve or preserve the value of the article. The article herein refers to an object eligible for a sales transaction. Examples of the article include electrical devices such as household appliances, furniture, home decor, fashion items, vehicles, sports and outdoor equipment, books, media, artworks, jewelry, office supplies, tools, toys, gardening supplies, pet supplies, travel goods, and medical or nursing care supplies.

The action information indicating an action for the value of the article may be information based on an image of the article captured by a camera or may be information based on speech and sound obtained by a microphone detecting sound related to the article.

### Additional Comments

The following are additional comments on the distributed ledger according to the embodiment or the variations described above. A blockchain will be described herein as an example of the distributed ledger; the same is true for other distributed ledgers.

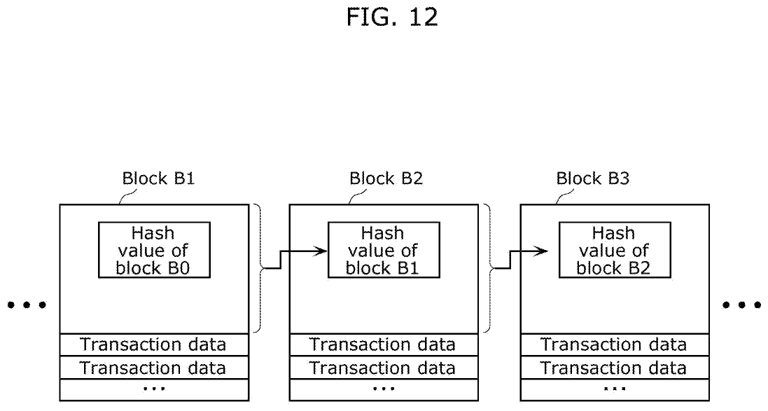

FIG. 12 is an explanatory diagram illustrating the data structure of a blockchain.

The blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tampered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

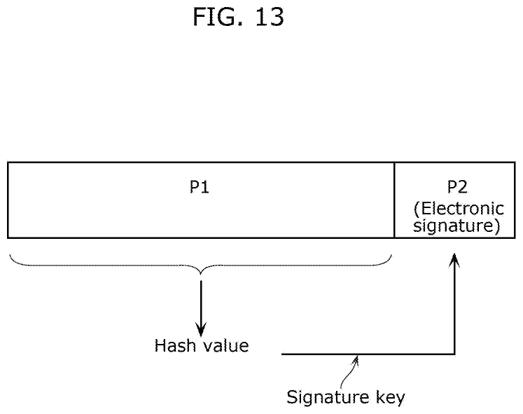

FIG. 13 is an explanatory diagram illustrating the data structure of transaction data.

The transaction data illustrated in FIG. 13 includes transaction body P1 and digital signature P2. Transaction body P1 is a data body included in said transaction data. Digital signature P2 is generated for the hash value of transaction body P1 by using a signature key of a creator of said transaction data; more specifically, digital signature P2 is generated by encrypting said hash value with a private key of the creator of said transaction data. Examples of the type of the digital signature include the elliptic curve digital signature algorithm (ECDSA), CRYSTALS-Dilithium, Falcon, and SPHINCS+.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

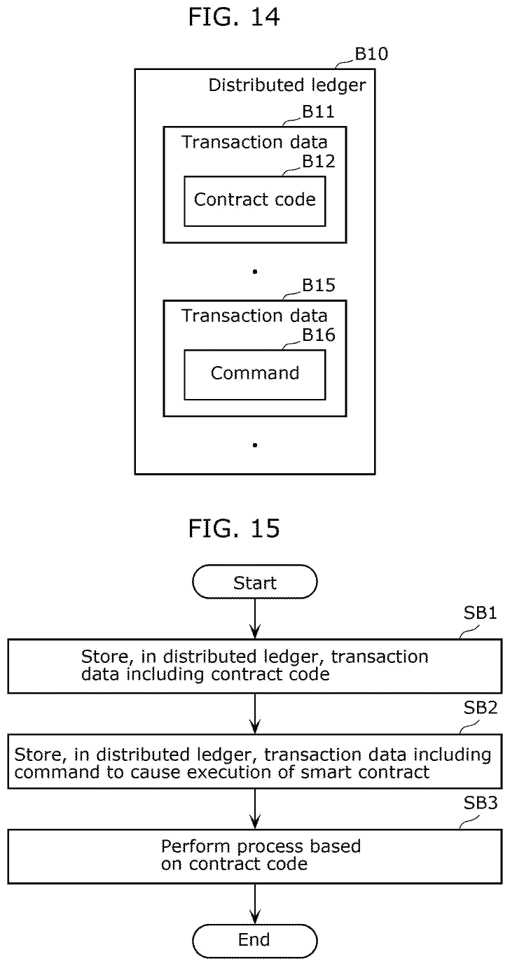

FIG. 14 is an explanatory diagram illustrating transaction data related to execution of a smart contract. FIG. 15 is an explanatory diagram illustrating processing related to execution of a smart contract.

With reference to FIG. 14 and FIG. 15, a series of processes related to the execution of the smart contract using the distributed ledger will be described.

In Step SB1, a node stores, in distributed ledger B10, transaction data B11 including contract code B12 in which the processing of the smart contract is written. For example, the node receives transaction data B11 from an information processing device via communication or the node itself generates transaction data B11 and thus, the node obtains transaction data B11, and stores obtained transaction data B11 in distributed ledger B10. Step SB1 is performed before the smart contract is executed.

In Step SB2, the node stores, in distributed ledger B10, transaction data B15 including command B16 to cause the execution of the smart contract. For example, the node receives transaction data B15 from an information processing device via communication and stores received transaction data B15 in distributed ledger B10.

In Step SB3, the node reads contract code B12 from distributed ledger B10 as a result of transaction data B15 including command B16 being stored in distributed ledger B10 in Step SB2, and performs a process based on contract code B12. The result of said process may be included in the transaction data and stored in distributed ledger B10.

When the distributed ledger system receives transaction data B15 including command B16 to cause the execution of the smart contract, the distributed ledger system automatically (in other words, without manual intervention) performs processes that follow command B16 by the above-described series of processes and can therefore perform the processes efficiently (in other words, at high speed or in a short time). Realization of the efficient processes results in the effect of reduced power consumption. Furthermore, since there is no manual intervention, tampering with information by a person, a fraudulent act, or a human error can be prevented. Moreover, since the result of the processes performed in this manner is stored in the blockchain, the result of the processes can be virtually impossible to tamper with.

Note that in the above-described embodiment or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the control method or the like according to each of the above-described embodiment and variations is a program described below.

Specifically, this program causes a computer to perform a control method that is performed by a device and includes: obtaining action information related to an action performed by a user on an electrical device to improve a state of the electrical device; calculating, based on the action information, an improvement level indicating a degree of improvement to the state of the electrical device; and determining, based on the improvement level, an amount of tokens to be granted to the user.

The control device and the like according to one or more aspects have been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### INDUSTRIAL APPLICABILITY

The present disclosure is useful as a control method or the like for prompting a user associated with an article including an electrical device to perform an action to improve the state of the article.

1. A control method executed by a device, the control method comprising:
obtaining action information related to an action performed by a user on an article to improve a state of the article;
calculating, based on the action information, an improvement level indicating a degree of improvement to the state of the article; and
determining, based on the improvement level, an amount of tokens to be granted to the user.

2. The control method according to claim 1, wherein
the action includes at least one of: performing a task on the article; requesting a specialized service provider for the task to perform the task; properly using the article; or designing a structure for enabling value measurement of the article.

3. The control method according to claim 2, further comprising:
obtaining error information indicating an error that has occurred in an electrical device that is the article, wherein
the action is performing, by the specialized service provider, a task to correct the error in the electrical device, as the task performed on the electrical device.

4. The control method according to claim 3, wherein
the improvement level is calculated based on a period from when the error occurs to when the task to correct the error is performed.

5. The control method according to claim 4, wherein
when the period is greater than or equal to a predetermined period, the determining is skipped.

6. The control method according to claim 4, further comprising:
obtaining, from a first terminal of the specialized service provider, request acceptance information indicating that a job request from an owner of the electrical device to perform the task to correct the error has been accepted, wherein
the period is a period from a point in time at which the error occurs to a point in time at which the request acceptance information is obtained.

7. The control method according to claim 6, wherein
the action includes: performing, by the specialized service provider for the task, the task to correct the error in the electrical device, as the task performed on the electrical device; and requesting, by the owner, the specialized service provider for the task to perform the task, and
in the determining, a first amount of tokens to be granted to the specialized service provider and a second amount of tokens to be granted to the owner are determined as the amount of tokens.

8. The control method according to claim 4, further comprising:
obtaining, from a first terminal of the specialized service provider, completion information indicating that the specialized service provider has completed the task to correct the error, wherein
the period is a period from a point in time at which the error occurs to point in time at which the completion information is obtained.

9. The control method according to claim 8, wherein
the action includes performing, by the specialized service provider, the task to correct the error in the electrical device, as the task performed on the electrical device, and
in the determining, a first amount of tokens to be granted to the specialized service provider is determined as the amount of tokens.

10.
The control method according to claim 4, further comprising:
obtaining a log indicating that the error in the electrical device has been corrected, wherein
the period is a period from a point in time at which the error occurs to a point in time at which the error is corrected.

11. The control method according to claim 3, wherein the electrical device is capable of communication via a network,
the action information is a log generated by the electrical device, and is obtained from the electrical device via the network, and
in the calculating, whether the user has properly used the electrical device is judged based on the log that is the action information, and the improvement level is calculated based on a result of the judging.

12.
The control method according to claim 1, wherein the device includes a distributed ledger in which a smart contract used in the calculating and the determining is stored,
in the obtaining, transaction data including the action information is obtained, and
in the calculating and the determining, the smart contract is executed based on the action information included in the transaction data.

13. A device comprising:
a processor; and
memory, wherein
using the memory, the processor:
obtains action information related to an action performed by a user on an article to improve a state of the article;
calculates, based on the action information, an improvement level indicating a degree of improvement to the state of the article; and
determines, based on the improvement level, an amount of tokens to be granted to the user.

14. A non-transitory computer-readable recording medium having stored therein a program for causing a computer to execute:
obtaining action information related to an action performed by a user on an article to improve a state of the article;
calculating, based on the action information, an improvement level indicating a degree of improvement to the state of the article; and
determining, based on the improvement level, an amount of tokens to be granted to the user.
